(19) United States
(12) Patent Application Publication
(10) Pub. No.: US 2023/0028263 A1
(43) Pub. Date: Jan. 26, 2023

(54) CARD RETAINERS

(71) Applicant: Hewlett-Packard Development Company, L.P., Spring, TX (US)

(72) Inventors: Xiang Ma, Spring, TX (US); Chan Woo Park, Spring, TX (US); Baosheng Zhang, Spring, TX (US); Richard Lin, Spring, TX (US); Fangyong Dai, Spring, TX (US); Chao-Wen Cheng, Taipei City (TW); Chien Fa Huang, Taipei City (TW); Roger Allen Pearson, Fort Collins, CO (US)

(73) Assignee: Hewlett-Packard Development Company, L.P., Spring, TX (US)

(21) Appl. No.: 17/783,058

(22) PCT Filed: Jan. 10, 2020
(86) PCT No.: PCT/US2020/013202

§ 371 Date: Jun. 7, 2022

(51) Int. Cl. G06F 1/18

(52) U.S. Cl. CPC G06F 1/185; G06F 1/186; G06F 1/187

(57) ABSTRACT

In an example, a card retainer may include a latch to removably engage with a free end of an expansion card. Further, a card retainer may include a pivot mount to attach the latch to a system board of a computing device. In some examples, the latch is movable about the pivot mount between an open position and a closed position. The latch may exert a bias force on the free end of the expansion card in order to retain the expansion card to the system board in a secure manner when the latch is disposed in the closed position.

### BACKGROUND

Electronic devices, including computing devices, may include expansion cards, system cards, or other components which may provide additional or enhanced functionality to the electronic device. Such components may be engaged with or installed into the electronic device through the use of expansion slots or other connectors. Such slots or connectors may sometimes be disposed within the electronic device and/or be attached to a system board of the electronic device.

### BRIEF DESCRIPTION OF THE DRAWINGS

FIG. 1 is a perspective view of an example card retainer.

FIG. 2A is a perspective view of an example computing device having an example card retainer.

FIGS. 2B-2D are perspective cutaway views of the example computing device of FIG. 2A having an example card retainer.

FIGS. 3A-3B are side views of an example card retainer.

FIG. 3C is a front view of the example card retainer of FIGS. 3A-3B.

FIG. 3D is a perspective view of an example card retainer.

FIG. 3E is a perspective view of another example card retainer.

FIG. 4A is a front, top, and side view of another example card retainer.

FIGS. 4B-4C are side views of an example computing device having an example card retainer.

FIGS. 5A-5B are perspective views of another example card retainer.

### DETAILED DESCRIPTION

Electronic devices, including computing devices, may include expansion cards, system cards, or other components which may provide additional or enhanced functionality to the electronic device. In some situations, such components may be used to supplement existing components of the device, e.g., increase the storage capacity of the electronic device. Such components may be engaged with or installed into the electronic device through the use of expansion slots or other card connectors. Such slots or card connectors may sometimes be disposed within the electronic device and/or be attached to a motherboard, a riser card, or other type of system board of the electronic device. Such components may have an edge connector having pins such that, upon the edge connector, and thus the component itself, being engaged with a card connector or slot of the electronic device, the pins on the edge connector may be engaged with complementary pins in the slot or connector, thereby enabling electronic communication between the system board and the expansion card or component.

In some situations, the edge connector of the expansion card or component may be disposed on a single edge, or portion thereof, of the component. Thus, upon installation, the expansion card or component may merely be constrained by the engagement of the edge connector with the slot or card connector of the system board, thereby leaving the other edges of the expansion card free or cantilevered along the system board. This may create an insecure attachment of the expansion card to the system board, wherein the expansion card may wobble, vibrate, or otherwise move or loosen from the connector or slot, thereby negatively affecting the function of the card.

An expansion card may have a first end comprising the edge connector, and a second end opposite the first end. In some situations, the first end may be referred to as a connector end and the second end may be referred to as a free end, since it is not engaged with the connector or slot. The free end may be fixed or constrained to the system board or another component of the electronic device by a fastener so as to provide a more secure attachment of the expansion card to the device. Such fasteners may directly or indirectly secure the free end of the expansion card to an aperture, a mounting standoff, or other fastening or attachment feature of the system board or other component. However, a tool such as a screw driver may be used to install and remove the fastener from the attachment feature, and thus from fixing the free end of the expansion card in place. Therefore, anytime a user may wish to install, swap, upgrade, or otherwise add or remove an expansion card to a computer system, the user may have to have a tool capable of installing and removing the fastener. This may be inconvenient to the user. Additionally, tools may be too large to access certain interior portions of a computing device, making installing or removing an expansion card very difficult. Therefore, it may be desirable for an electronic device, or a system board thereof, to have a simple way of securely fastening and removing a system card or supplemental component to or from the system board that may omit the need for tools.

Implementations of the present disclosure provide card retainers that may securely attach an expansion card or other supplemental component to an electronic device, or a system board thereof. Further, examples described herein may be able to secure a free end of an expansion card to a system board or other component without the use of a tool.

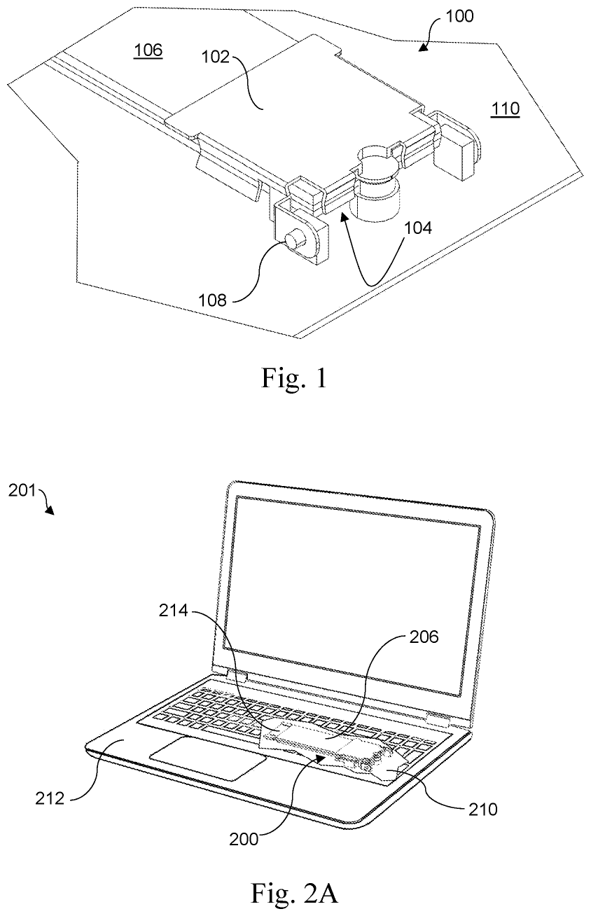

Referring now to FIG. 1, a perspective view of an example card retainer 100 is illustrated. Card retainer 100 may include a latch 102 to removably engage with a free end 104 of an expansion card 106. Further, card retainer 100 may include a pivot mount 108 to attach the latch 102 to a system board 110 of a computing device. In some examples, the latch 102 is movable about the pivot mount 108 between an open position and a closed position. FIG. 1 illustrates the latch 102 as being disposed in the closed position. In some examples, the latch 102 may at least partially enclose the free end 104 of the expansion card 106 when disposed in the closed position. In other examples, latch 102 may clip or latch on to a portion of the free end 104 in order to secure the free end 104. The latch 102 may exert a bias force on the free end 104 of the expansion card 106 in order to retain the expansion card 106 to the system board in a secure manner when the latch 102 is disposed in the closed position.

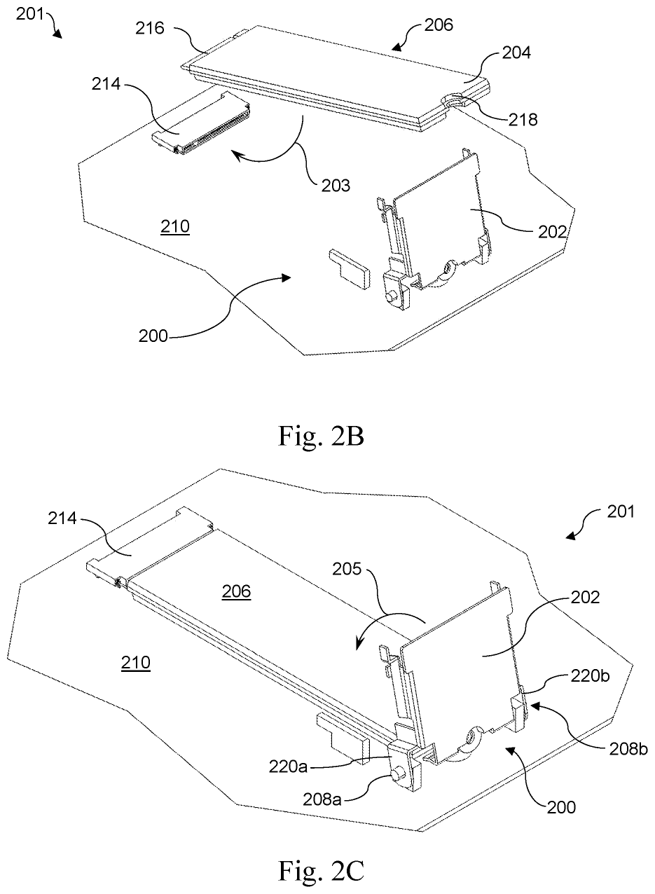

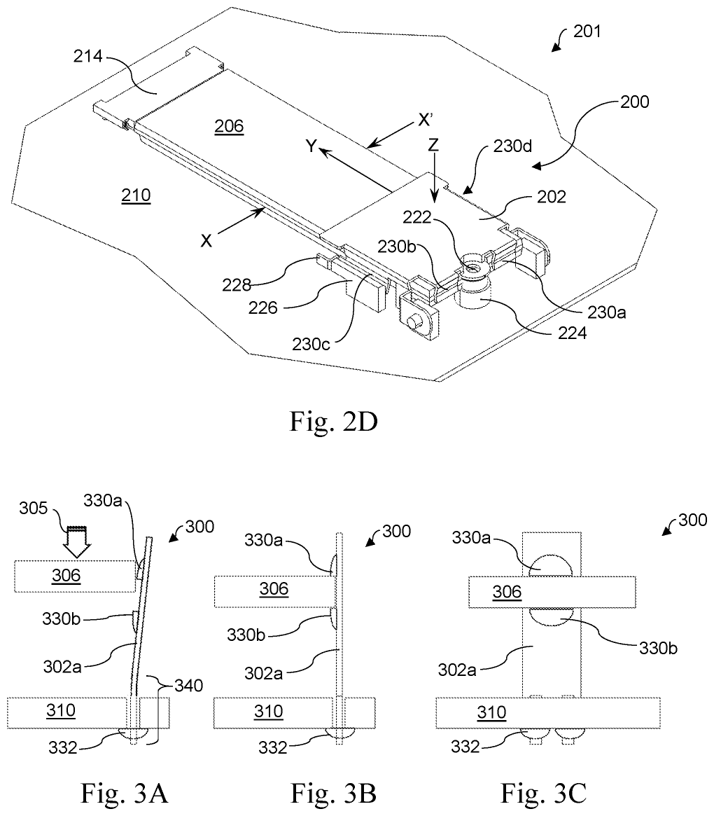

Referring now to FIG. 2A, a perspective view of an example computing device 201 having an example card retainer 200 is illustrated. Example card retainer 200 may be similar to other example card retainers described above. Further, the similarly-named elements of example card retainer 200 may be similar in function and/or structure to the respective elements of other example card retainers, as they are described above.

Computing device 201 may include an enclosure or housing 212. The housing 212 may electrically and mechanically support and/or house components of the computing device 201. Such components may include processors, storage drives, memory, power supplies, or other suitable components for use with a computing device 201. In some implementations, the computing device 201 may include a system board 210 disposed within the housing 212. The system board 210 may include a printed circuit board (PCB) and may be a motherboard or another type of circuit board. In some examples, the system board 210 may include a card connector 214 to receive and operably engage with an expansion card 206. The card connector 214 may include pins, pads, contacts, or other components to electrically and/or mechanically engage with the expansion card 206, or an edge connector or other portion thereof. In some examples, the card connector 214 may be an M.2 interface to engage with a complementary storage drive.

The expansion card 206 may be a component to enhance or improve the functionality of the computing device 201, in some implementations. In other examples, the expansion card 206 may be a component to support the nominal or ordinary function of the computing device 201. The expansion card 206 may be a storage drive, memory, a graphics card, a network card, or another type of computing component that may engage with a card connector 214. In some implementations, the expansion card 206 may include an edge connector to mechanically and electrically engage with the card connector 214 such that the computing device 201 can electrically communicate with the expansion card 206. In some examples, the expansion card 206 may be a flash memory, flash storage drive, or solid-state storage drive such as an M.2 form factor storage drive. In other examples, the expansion card 206 may be a storage drive of a different form factor or specification.

Computing device 201 may be a notebook computer or mobile workstation, in some examples. In other examples, computing device 201 may be another type of computing device, such as a desktop computer, a server and/or server rack or blade, an imaging device such as a printer or copier, or an additive manufacturing machine (e.g., three-dimensional (3D) printer). In yet other examples, computing device 201 may be another type of electronic device that may include an expansion card 206 and/or a card connector 214.

Referring now to FIG. 2B, a perspective cutaway view of example computing device 201 is illustrated, wherein the enclosure and other components are omitted for clarity. The computing device 201 is illustrated as having the expansion card 206 not engaged with the card connector 214. The expansion card 206 may include a first end, sometimes referred to as a connector end 216, which may include an edge connector that is mechanically and electrically complementary to the card connector 214. When the expansion card 206 is engaged with the card connector 214, and thus the computing device 201, the computing device 201 may electrically communicate with the expansion card 206 via the card connector 214 and the edge connector of the expansion card 206.

In order to install or engage the expansion card 206 with the card connector 214, and thus the computing device 201, the connector end 216 of the expansion card 206 may be inserted into the card connector 214, e.g., along direction 203. Further, the expansion card 206 may be pivoted or moved downward and along example direction 203 towards a substrate on which the card connector 214 may be disposed, e.g., a system board 210, in order to fully seat or engage the connector end 216 with the card connector 214. The expansion card 206 may additionally include a second end, sometimes referred to as a free end 204, opposite the connector end 216.

Referring additionally to FIG. 2C, a perspective cutaway view of the computing device 201 is illustrated wherein the expansion card 206 is engaged with the card connector 214. The connector end 216 is engaged with the card connector 214 and the expansion card 206 has moved along example direction 203 to securely and fully seat the edge connector of the connector end 216 into the card connector 214. As such, the expansion card 206 now extends from the card connector 214 in a cantilevered fashion. As such, the second end is considered a free end 204. The free end 204 may thus include a retention feature 218 in order to secure the free end 204 to the substrate (e.g., the system board 210), and eliminate the cantilevered nature of the free end 204. The card retainer 200 may be movable between an open position (illustrated in FIGS. 2B-2C) and a closed position, e.g., along direction 205, in order to secure the free end 204 of the expansion card 206.

In order for the card retainer 200 to move between the open and closed positions, the card retainer 200 may include a latch 202 that is movable between an open and closed position. The latch 202 may be a rigid or semi-rigid member capable of holding an expansion card 206 to a surface when the latch 202 is sufficiently held in place itself. Further, the latch 202 may be structured and/or sized so as to be able to removably engage with the free end 204 of the expansion card 206.

The card retainer 200 may further include a first pivot mount 208a and second pivot mount 208b (referred to collectively as pivot mounts 208). In some implementations, the card retainer 200 may include a single pivot mount, and in other examples, may include another number of pivot mounts. The pivot mounts 208 may be features or members that enable the latch 202 to rotate, pivot, bend, or otherwise move, relative to the system board 210 and the expansion card 206. In some examples, the pivot mounts 208 may be fixed, either directly or indirectly through intermediary components, to the system board 210. The pivot mounts 208 may attach to or engage with the latch 202, or a portion thereof.

In some implementations, the latch 202 may have a first pivot bracket 220a and a second pivot bracket 220b, (referred to collectively as pivot brackets 220) which may engage with the first pivot mount 208a and the second pivot mount 208b, respectively. In some implementations, the pivot mounts 208 and the pivot brackets 220 may rotatably or pivotably engage with each other so as to enable the latch 202 to rotate or pivot relative to the system board 210 between the open and closed positions. In some implementations, the pivot mounts 208 may include a post, pivot, axle, or another member which may engage with a complementary aperture, bore, window, or opening on the respective pivot bracket 220 to enable such rotation or pivot of the latch 202. In some implementation, the pivot brackets 220 and the latch 202 may be a unitary component and formed as a single piece. In other implementations, the pivot brackets 220 may be separate components that are attached to or assembled on to the latch 202.

Referring now to FIG. 2D, a perspective cutaway view of the computing device 201 is illustrated wherein the latch 202 of the card retainer 200 is disposed in the closed position. The latch 202 has been pivoted or moved, e.g., along direction 205 of FIG. 2C, towards the expansion card 206 so as to engage with the free end 204 of the expansion card 206. The latch 202 has sufficiently engaged and/or mated with the free end 204 of the expansion card 206 so as to secure the free end 204 relative to the system board 210 and card connector 214, and eliminate the cantilevered nature of the expansion card 206. In some examples, in order to transition from the open position to the closed position, the latch 202 may rotate about the pivot mounts 208 on to a top face of the expansion card 206. In some implementations, the latch 202 may at least partially enclose the free end 204 when the latch 202 is in the closed position.

In some implementations, the system board 210 may include a mounting standoff 224 extending from the system board 210. When the expansion card 206 is installed into the card connector 214, the retention feature 218 may align with the mounting standoff 224 such that the mounting standoff 224 engages with the retention feature 218 and helps to support the free end 204 through such engagement. In some implementations, the retention feature may be a cutout or recess in the top face and a bottom face of the expansion card 206. In some examples, the retention feature 218 may be rounded and/or semi-circular, and the mounting standoff 224 may have a complementary rounded and/or circular geometry so as to mate with the portion of the retention feature 218 extending into the bottom face of the expansion card 206. Thus, the expansion card 206 may rest on top of the mounting standoff 224. In some examples, the latch 202, when transitioned to the closed position, may engage with the portion of the retention feature 218 that extends into the top face of the expansion card 206. Thus, the latch 202 may exert a clamping force or compression on to the free end 204 of the expansion card 206 when the latch 202 is in the closed position so as to fix the free end 204 in between the latch 202 and the mounting standoff 224. This secures the free end 204 in a direction orthogonal or normal to the system board 210, e.g., along the Z-direction as illustrated in FIG. 2D.

In some implementations, the latch 202 may further include a fastener opening 222 extending through a portion of the latch 202 that is aligned with the retention feature 218 and the mounting standoff 224 when the latch 202 is in the closed position. The fastener opening 222 may be a window, aperture, slot, or other opening extending through a thickness of the latch 202. The fastener opening may be sized and/or structured sufficiently so as to be able to receive and mate with a complementary fastener. In some implementations, the fastener opening 222 may be a round opening to receive the shank and/or threaded portion of a threaded fastener, such as a bolt or machine screw. Once the latch 202 is disposed in the closed position, thereby securing the free end of the expansion card 206, a user may desire to secure the expansion card 206 in place yet even further. This may be desired in situations where the computing device 201 may be in a mobile or moving environment, or may be especially susceptible to drops, bumps, or other environmental shocks. In such a situation, a fastener (not shown) may be inserted through the fastener opening 222 and tightened into the mounting standoff 224. This may lock the latch 202 into the closed position and provide extra security to the expansion card 206.

In some examples, the latch 202 may further include a plurality of spring brackets 230a, 230b, 230c, and 230d, hereinafter referred to collectively as spring brackets 230. In the illustrated example, spring brackets 230a-b may be disposed on the latch adjacent to a terminating, longitudinal, or distal face of the free end of the expansion card 206. Further, spring brackets 230c and 230d may be disposed on the latch 202 adjacent to opposing lateral faces of the free end of the expansion card 206. Each of the spring brackets 230 may be a resilient component capable of elastic deformation or returning to its original shape and/or position after undergoing a deformation. Upon experiencing a deformation, each spring bracket 230 may exert a normal or reactive force proportional to the magnitude of the deformation. In some examples, the spring brackets 230 may be constructed of a metallic material, such as spring steel. In further examples, each of the spring brackets 230 may be a unitary extension of the latch 202 and may be formed by bending or stamping a portion of the latch 202.

When the latch 202 is in the closed position, spring brackets 230a and 230b may contact and exert a compressive bias force on the distal face of the free end in order to bias the expansion card 206 in a longitudinal manner, e.g., along the Y-direction, towards the card connector 214. Additionally, spring brackets 230c and 230d may exert a compressive bias force on each of the two lateral side faces of the free end in order to bias the expansion card 206 in a lateral manner, e.g., along the X-direction and X′-direction, respectively. Thus, the plurality of spring brackets 230 may squeeze or latch on to the free end of the expansion card 206 when the latch 202 is in the closed position in order to secure the free end from movement relative to the system board 210.

In some implementations, the card retainer 200 may further include a locking hook 228 to engage with a locking block 226 when the latch 202 is disposed in the closed position. The locking hook 228 may extend from the latch 202 towards the location of the locking block 226 such that, upon the latch 202 approaching the closed position, the locking hook 228 and the locking block 226 contact and engage one another. In some examples, the locking hook 228 may be a bendable resilient member and the locking block 226, upon contacting the locking hook 228, may bend the locking hook 228 out of its neutral position until the locking hook 228 is moved past a shelf or latch portion of the locking block 226. The locking hook 228, through its resilient nature, may then move back towards its neutral position until it latches underneath a portion of the locking block 226. Thus, the locking hook 228 may retain the latch 202 in the closed position through its engagement with the locking block 226.

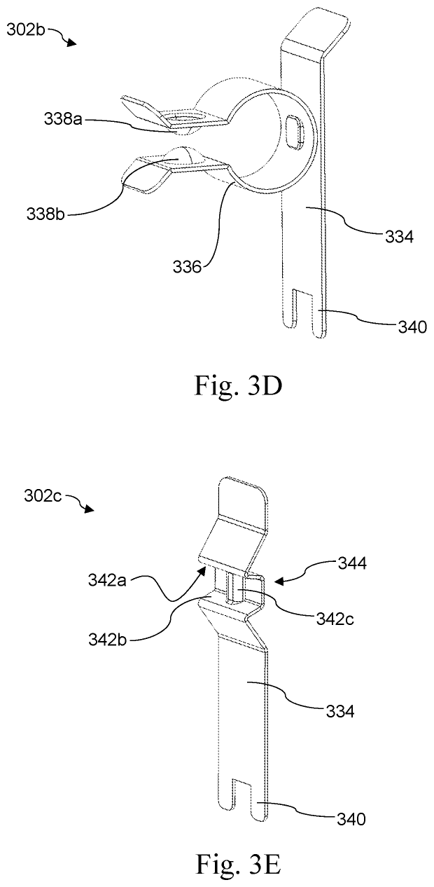

Referring now to FIGS. 3A-3B and FIG. 3C, side views and a front view of an example card retainer 300 are illustrated, respectively. Card retainer 300 may be used to removably and securely hold a free end of an expansion card 306 in place in engagement with a card connector (not shown) of a computing device (not shown). Card retainer 300 may include a latch 302a to removably engage with a free end of an expansion card 306. Further, card retainer 300 may also include a mounting portion 340 to fix the latch 302a to a system board 310 of a computing device. The latch 302a may be a resilient component capable of undergoing elastic deformation, and may be bendable about the mounting portion 340 between an open position (illustrated in FIG. 3A) and a closed position (illustrated in FIGS. 3B-C). In some examples, the latch 302a may be a sheet metal component and may be substantially planar in structure. The mounting portion 340 may extend through the system board 310 and may be fixed to an underside of the system board 310, in order to fix the latch 302a to the system board 310. In some examples, the mounting portion 340 is to attach to the system board 310 using a metallic fastener or may be soldered to the system board 310. Both the metallic fastener and the solder may ground the latch 302a, and thus the expansion card 306 when the latch 302a is disposed in the closed position and the expansion card 306 is inserted into the card connector (not shown) on the system board 310. Stated otherwise, the metallic fastener or solder and the latch 302a may complete an electrical circuit between the expansion card 306 and the system board 310 sufficient to act as a ground connection for the expansion card 306.

In other examples, the mounting portion 340 may fix the latch 302a to an interior side or face of a chassis (not shown) of the computing device. Such a face of a chassis may be disposed underneath the system board 310 such that the latch 302a extends from the face of the chassis, through or past an edge of the system board 310, and to the expansion card 306 to engage with the free end thereof. In such an example, the attachment of the mounting portion 340 to the chassis of the computing device may act as a ground circuit for the expansion card 306.

The latch 302a may further include a latching feature disposed at a distal end of the latch 302a from the mounting portion 340. The latching feature may removably engage with a free end of the expansion card 306 in order to secure the free end. In some examples, the latching feature may engage with a complementary retention feature (similar to retention feature 218, above) of the free end of the expansion card 306 in order to secure the free end. In this example, the latching feature may include a first portion 330a and a second portion 330b. Each of the first portion 330a and the second portion 330b may be a shelf, shoulder, or other type of protrusion extending from the latch 302a. When the card retainer 300, or the latch 302a thereof, is engaged with the free end of expansion card 306, the first portion 330a of the latching feature may engage with and/or clamp on to a top face of the expansion card 306. Similarly, the second portion 330b may engage with, or support from below, a bottom face of the expansion card 306, opposing the top face. Thus, the latching feature, when the latch 302a is engaged with the expansion card 306, may hold a portion of the free end of the expansion card 306 in between the first and second portions 330a and 330b in order to secure the free end of the expansion card 306 and eliminate a cantilevered characteristic of the installed expansion card 306.

In order to install an expansion card 306 into the computing device, it may first be inserted into or engaged with a card connector (not shown). At this stage, the free end of the expansion card 306 may be extending from the card connector in a cantilevered fashion, and thus may be insecure. The free end may then be pushed down, e.g., along direction 305, into engagement with the latch 302a. The first portion 330a of the latching feature may contact the free end of the expansion card 306 and be pushed back out of the way, as illustrated in FIG. 3A. Thus, the latch 302a may be bendable in a resilient fashion about the mounting portion 340 in order to enable this movement of the latching feature. Once the free end is clear of the first portion 330a of the latching feature, the latch 302a may, through its resilient nature, move back towards the expansion card 306 and latch on to or engage with the free end, as illustrated in FIGS. 3B-3C, in order to support the free end and eliminate the cantilevered nature of the installed expansion card 306. In some examples, due to the resilient nature of the latch 302a, the latch 302a may exert a bias force on the free end of the expansion card 306 in order to retain the expansion card 306 to the card connector and thus system board 310 when the latch 302a is in the closed position.

Referring now to FIG. 3D, another example latch 302b of card retainer 300 is illustrated. Latch 302b may include mounting portion 340, as described above. Further, latch 302b may include a latch body 334, and another example latching feature 336. The latching feature 336 may be attached to the latch body 334 at a distal end from the mounting portion 340. The latch body 334 may be a resilient component capable of undergoing elastic deformation, and, thus, may be bendable about the mounting portion 340, as described above. Thus, the latching feature 336 may also be movable about the mounting portion 340.

In some implementations, the latching feature 336 may extend from the distal end of the latch body 334 and may include a first portion 338a and a second portion 338b. First and second portions 338a and 338b may be protrusions that extend from the latching feature 336 towards one another. The first and second portions 338a and 338b may be removably engageable with a free end of an expansion card and, in some examples, may be engageable with a complementary retention feature of the free end (e.g., retention feature 218). In some examples, the first and second portions 338a and 338b may have a rounded, semi-spherical, or dome-shaped structure so as to engage with a rounded retention feature cut out of the free end of the expansion card. When the expansion card is engaged with a card connector, the latching feature may engage with the free end of the expansion card so as to secure the free end.

Referring now to FIG. 3E, another example latch 302c of card retainer 300 is illustrated. Latch 302c may include a mounting portion 340 and a latch body 334, as described above. Further, latch 302c may include a latching feature 344 including a first portion 342a, a second portion 342b, and a third portion 342c. The latching feature 344 may engage with the free end of the expansion card so as to secure the expansion card when the expansion card is engaged with a complementary card connector within the computing device. Specifically, the first portion 342a may be a sloped surface to engage with a top face of the free end of the expansion card. Similarly, the second portion 342b may also be a sloped edge, oriented opposite to the first portion 342a, to engage with a bottom face of the free end of the expansion card. The sloped aspect to the first and second portions 342a and 342b, along with the resilient and bendable nature of the latch body 334, may enable the latch 302c to exert a longitudinal bias force on to the free end of the expansion card in order to secure the free end of the expansion card. The third portion 342c may be a lug, rib, or other protrusion extending from the latch body 334 towards the free end of the expansion card in order to engage with a complementary retention feature cut out of the free end of the expansion card. In some examples, the latch 302c and its constituent components may be a single unitary component bent, stamped, or otherwise formed from sheet metal.

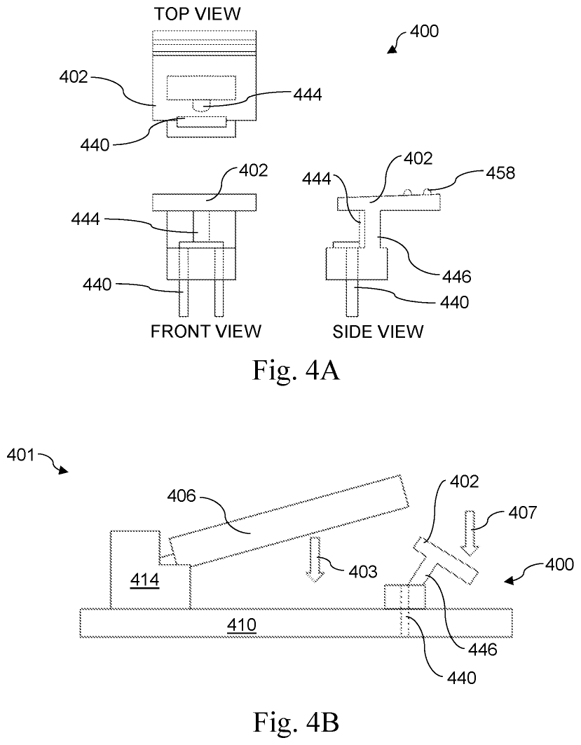

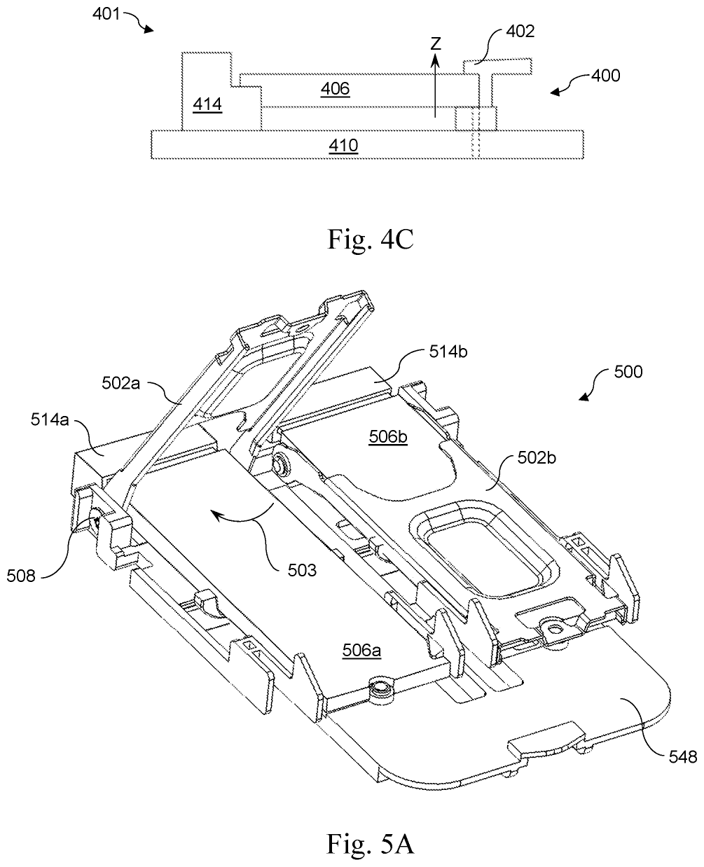

Referring now to FIG. 4A, a front, top, and side view of an example card retainer 400 is illustrated. Card retainer 400 may include a latch 402 having a latch body 446. Further, the card retainer 400 may include a mounting portion 440 to fix or attach the card retainer 400 to a system board of a computing device. The mounting portion 440 may be a stake, staple, pins or lugs, or another type of fastener suitable to attach the card retainer 400 to a system board. In some examples, the latch body 446 may be bendable or otherwise movable relative to the mounting portion 440, and thus the system board. In some implementations, the latch 402 and/or the latch body 446 may be constructed of a polymer material. The card retainer 400 may also include a latching feature 444. The latching feature 444 may be a lug, rib, or another type of protrusion extending from the latch body 446. The latching feature 444 may removably engage with a retention feature of an expansion card, in some examples. Further, the latch 402 may include a grip portion 458. Grip portion 458 may include a protrusion or a number of protrusions extending from the latch 402 in order to make it easier for a user to press, move, or otherwise manually engage the latch 402.

Referring now to FIG. 4B, a side view of an example computing device 401 having an example card retainer 400 is illustrated wherein the latch 402 is in an open position. The computing device 401 may include a system board 410 and a card connector 414 disposed on the system board 410. Further, the computing device 401 may include an expansion card 406 to engage with the card connector 414 at a connector end and in a removable fashion. The card retainer 400 may be disposed on the system board 410 (via the mounting portion) at or near the free end of the expansion card 406.

The expansion card 406 may be inserted into the card connector 414 and moved downward, e.g., along direction 403, in order to fully seat the expansion card 406 and enable electrical communication between the expansion card 406 and the computing device 401. Further, the free end of the expansion card 406 may removably engage with the latch 402 when the latch 402 is disposed in an open position, as illustrated. In order to dispose the latch 402 in the open position, a user or other mechanism may push on or actuate the latch 402, e.g., along direction 407. Similarly, the expansion card 406 may disengage from the card retainer 400 and the card connector 414 when the latch 402 is in the open position.

Referring now to FIG. 4C, a side view of the example computing device 401 having the example card retainer 400 is illustrated wherein the latch 402, and thus the card retainer 400, is disposed in a closed position. The expansion card 406 has been fully engaged with the card connector 414, and the latch 402 has been engaged with the free end of the expansion card 406 so as to fix or secure the free end of the expansion card 406. In order to transition the latch 402 from the open position to the closed position, the latch 402 may be released by the user or other mechanism, and the resilient and bendable nature of the latch 402 and latch body 446 may cause the latch 402 to move towards the free end and, in some examples, apply a bias force on to the free end in order to hold the expansion card 406 into engagement with the card connector 414. In some examples, the latch 402 may overhang a portion of the free end, thereby retaining the free end from movement, e.g., in the Z-direction as illustrated. In some examples, the mounting portion 440 may be a metallic component and may complete an electrical circuit between the free end of the expansion card 406 and the system board 410 in order to function as a ground for the expansion card 406.

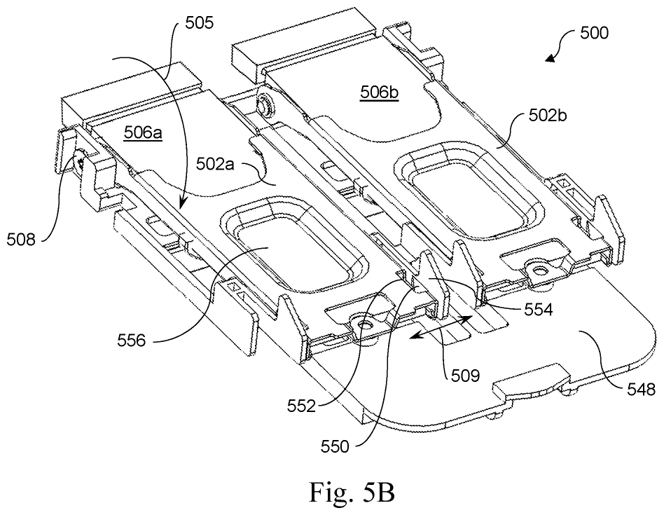

Referring now to FIG. 5A, a perspective view of another example card retainer 500 is illustrated. Card retainer 500 may include a latch 502a and a pivot mount 508, about which the latch 502a may pivot or rotate. In some examples, latch 502a may be referred to as a first latch 502a and card retainer 500 may have a second latch 502b and a second pivot mount about which second latch 502b may pivot or rotate, similar in fashion to first latch 502a and pivot mount 508. In other examples, card retainer 500 may have a differing number of latches and a corresponding number of pivot mounts, depending on how many expansion cards card retainer 500 is to support. Card retainer 500 may include a carriage 548 to support any desired number of expansion cards, latches, and pivot mounts. The carriage 548 may have any size and/or structure suitable to mechanically support the desired number of such components.

Card retainer 500 may be disposed within a computing device (not shown) and fixed or attached to a system board (not shown) in order to retain and secure expansion cards within the computing device. In some examples, the carriage 548 is attached or fixed to the system board. Further, the computing device may have a first card connector 514a and a second card connector 514b, each to removably engage with a connector end of an expansion card, e.g., first expansion card 506a and second expansion card 506b, respectively. The first card connector 514a and second card connector 514b may be disposed on the system board and may enable electrical communication between the respective expansion card and the computing device.

In some examples, the pivot mount 508 may be disposed on or part of the carriage 548. Pivot mount 508 may further be disposed adjacent or near the first card connector 514a, and thus the connector end of expansion card 506a. Such placement of the pivot mount 508 may enable the first latch 502a to pivot or move relative to the first expansion card 506a so as to clamp down on to a free end of the first expansion card 506a.

In the illustrated example, second expansion card 506b is engaged with second card connector 514b and secured by second latch 502b in a closed position. First expansion card 506a has been inserted into first card connector 514a, e.g., along direction 503, to enable electrical communication between the first expansion card 506a and the computing device via the first card connector 514a. First latch 502a is disposed in an open position in FIG. 5A, thereby not securing the first expansion card 506a in position and subjecting first expansion card 506a to disconnection from the first card connector 514a due to outside shock, vibration, or other unwanted environmental occurrences. In order to easily protect the first expansion card 506a from such undesirable occurrences and to ensure reliable engagement between the first expansion card 506a and the first card connector 514a, the first latch 502a may be moved from the open position to the closed position, as illustrated in FIG. 5B.

Referring now to FIG. 5B, a perspective view of card retainer 500 is illustrated wherein the first latch 502a is disposed in the closed position. The first latch 502a was moved about pivot mount 508, e.g., along direction 505, to the closed position from the open position. Upon being disposed in the closed position, the first latch 502a is pressed down on to the first expansion card 506a, and/or the free end thereof, and locked into place by locking hook 550, thereby preventing any upward motion of the first expansion card 506a. The first latch 502a may at least partially enclose or cover the free end of the first expansion card 506a when disposed in the closed position.

In some implementations, locking hook 550 may be a resilient and bendable member capable of undergoing elastic deformation. Upon the first latch 502a moving downward towards the closed position, the first latch 502a may contact the locking hook 550 and press the locking hook 550 out of the way to allow a locking shelf 552 attached to the first latch 502a to pass by the locking hook 550. In some implementations, the locking hook 550 may have a sloped or angled top side to enable the first latch 502a, while undergoing downward motion, to push the locking hook 550 in a lateral direction, e.g., along direction 509. Once the locking shelf 552 is past the locking hook 550, the locking hook 550 may be free to move back to its neutral position, overhanging or otherwise disposed over the locking shelf 552 to prevent the locking shelf 552, and thus the first latch 502a to which it is attached, from moving back towards the open position. In order to unlock the first latch 502a, an unlock tab 554 may be manually actuated by a user or actuated by another mechanism. Actuation of the unlock tab 554 may involve sliding the unlock tab 554, and thus the locking hook 550 attached to it, laterally, e.g., along direction 509, relative to direction 505. This may enable the locking hook 550 to be clear of the locking shelf 552 and allow the first latch 502a to move from the closed position back towards the open position.

In some examples, each latch of the card retainer 500 may have its own locking hook, locking shelf, and unlock tab so that each latch may be individually opened and closed. Further, in some implementations, the locking hooks and unlock tabs may be unitary portions of the carriage 548, i.e., they may be molded onto or with the carriage 548 as a whole.

Further, in some examples, each latch may have a pressure pad, e.g., first latch 502a may have a pressure pad 556. The pressure pad 556 may be an indentation in the first latch 502a such that, upon the first latch 502a being disposed in the closed position, the pressure pad 556 may press or apply force to the retained first expansion card 506a such that the first latch 502a provides a secure fitment between the carriage 548 and the first expansion card 506a and prevents the first expansion card 506a from disengaging from the first card connector 514a.

What is claimed is:

1. A card retainer, comprising:
a latch to removably engage with a free end of an expansion card; and
a pivot mount to attach the latch to a system board of a computing device;
wherein the latch is movable about the pivot mount between an open position and a closed position, the latch to exert a bias force on the free end of the expansion card to retain the expansion card to the system board when the latch is in the closed position.

2. The card retainer of claim 1, wherein the latch is to partially enclose the free end of the expansion card when the latch is in the closed position.

3. The card retainer of claim 1, wherein the latch is to rotate about the pivot mount on to a top face of the expansion card when the latch is transitioned from the open position to the closed position.

4. The card retainer of claim 1, wherein the latch includes a plurality of spring brackets to exert a compressive bias force on a distal face of the free end of the expansion card and each of two lateral side faces of the free end of the expansion card when the latch is disposed in the closed position.

5. The card retainer of claim 1, further comprising a fastener opening on the latch, the fastener opening to align with a retention feature on the free end of the expansion card when the latch is in the closed position.

6. The card retainer of claim 1, further comprising a locking hook to engage with a locking block when the latch is disposed in the closed position, the locking hook to retain the latch in the closed position.

7. A card retainer, comprising:
a latch to removably engage with a free end of an expansion card; and
a mounting portion to fix the latch to a system board of a computing device;
wherein the latch is bendable about the mounting portion between an open position and a closed position, the latch to exert a bias force on the free end of the expansion card to retain the expansion card to the system board when the latch is in the closed position.

8. The card retainer of claim 7, wherein the latch includes a latching feature disposed at a distal end from the mounting portion, the latching feature to removably engage with a complementary retention feature of the free end of the expansion card.

9. The card retainer of claim 7, wherein the mounting portion is to extend through the system board and is fixed to an underside of the system board.

10. The card retainer of claim 7, wherein the mounting portion is to fix the latch to an interior side of a chassis of the computing device, the latch to extend from the chassis and past the system board to the expansion card.

11. The card retainer of claim 7, wherein the mounting portion is attached to the system board with a metallic fastener, the metallic fastener to ground the expansion card when the latch is disposed in the closed position with the free end of the expansion card.

12. A computing device, comprising:
a housing;
a system board disposed within the housing;
a card connector disposed on the system board;
an expansion card to engage with the card connector at a connector end; and
a card retainer disposed on the system board at a free end of the expansion card, opposite the connector end, the card retainer comprising:
a latch to removably engage with the free end of an expansion card; and
a pivot mount to attach the latch to the system board;
wherein the latch is movable about the pivot mount between an open position and a closed position, the latch to partially enclose and exert a bias force on the free end of the expansion card when disposed in the closed position to retain the expansion card in an engaged position with the connector.

13. The computing device of claim 12, wherein the latch includes a fastener opening and the system board includes a mounting standoff, the fastener opening to align with the mounting standoff and a retention feature of the expansion card when the latch is in the closed position such that a fastener may fix the latch and the retention feature to the mounting standoff.

14. The computing device of claim 12, wherein the expansion card is able to disengage from the connector if the latch is disposed in the open position.

15. The computing device of claim 12, wherein the expansion card is a solid-state storage drive (SSD) and the card connector is an M.2 interface.
